(19) United States
(12) Patent Application Publication
(10) Pub. No.: US 2012/0051572 A1
(43) Pub. Date: Mar. 1, 2012

(54) Shield with integrated loudspeaker

(76) Inventor: Curtis E. Graber, Woodburn, IN (US)

(21) Appl. No.: 12/807,014

(22) Filed: Aug. 26, 2010

(51) Int. Cl. H04R 1/02

(52) U.S. Cl. 381/334

(57) ABSTRACT

A shield having a front major surface and a rear major surface supports a loudspeaker array mounted to the shield to project sound outwardly from the front major surface. A signal source for driving the loudspeaker array is mounted to the rear major surface and supplies signals for recorded auditory warnings or tones to the loudspeaker array. The signal source may include a microphone, a receiver allowing reproduction over the high intensity loudspeaker of broadcast or narrowcast signals from a remote location or a recorded signal playback device. If a recorded signal playback device is provided it may further allow for storage of new or replacement signals.

### BACKGROUND

1. Technical Field

The field relates to non-lethal crowd control tools, and, more particularly, to shields incorporating integrated loudspeaker arrays and providing for centralized, remote activation.

2. Description of the Art

A common contributing factor to injuries occurring during civil disturbances is the inability to avoid direct physical contact between police or military units on the one hand and a crowd. Ostensibly non-lethal riot control equipment, such as water cannons and rubber bullets, can be difficult to deploy or their use can result in serious injuries. When crowds close within 50 meters to police lines the police become exposed to thrown objects.

Crowd control can be made more effective if the police response is coordinated. Urban environments are often acoustically chaotic with acoustically dead areas occurring just around corners from acoustically live areas. Sound trucks have been used but these may be poorly positioned to reach all areas that need to be reached. A sound system which can be implemented through distributed speakers, all controlled from a location affording a commander immediate and direct intelligence about the overall situation, would allow the commander to better use sound to reach the crowd. Setting up distributed sound reproducing units to allow constructive interference can increase the strength of the reproduced pressure wave.

Shields have long been one tool used for crowd control. U.S. Pat. No. 6,397,943 to Tocci et al. taught a capture shield with an integrated high intensity light array. The light array produced a burst of very bright light intended to surprise an individual target and force the target to close his or her eyes. This was intended to give an officer a means of distracting a subject in order to ease capture of the subject. The advantages given for using light were that light was language independent, produced distraction and fear, temporarily impaired vision, could produce disorientation and nausea and reduced a subject's ability to perform violent acts. An adaptation of the shield for riot control was shown in FIG. 14 of Tocci et al. Light emission for the riot version of the shield was described as constant or flickering.

United States Patent Application Publication No. 2007/0125224 to Thomas related to a “Tactical Protective Shield” incorporated a speaker allowing the officer carrying the shield to use the shield as a public address system or for playing a recorded message.

### SUMMARY

A shield having front major and rear major surfaces supports a loudspeaker array mounted through the shield to project sound outwardly from the front major face. A driver for the loudspeaker array is mounted to the rear major surface and supplies signals to the array from one of a plurality of selected sources. The sources may include recorded auditory warnings or tones, a microphone, a recorded signal playback device, or a receiver allowing reproduction over the loudspeaker array of signals from a remote location. Operator controls may be provided for local selection of a signal or the driver may be remotely actuable. Provision of remote sourcing of the signal to be reproduced allows signals between multiple, distributed units to be coordinated.

### BRIEF DESCRIPTION OF THE DRAWINGS

Understanding of the following description may be enhanced by reference to the accompanying drawings, wherein:

FIG. 1 is a front perspective view of an integrated shield and public address system.

FIG. 2 is a rear quartering perspective view of the shield of FIG. 2.

FIG. 3 is a block diagram of the sound reproduction system.

FIG. 4 is a plan view of a loudspeaker array.

FIG. 5 is a partial cross-section of the lower portion of the shield of FIGS. 1 and 2.

FIG. 6 is a front plan view of a plurality of shields positioned for coordinated sound reproduction.

### DETAILED DESCRIPTION

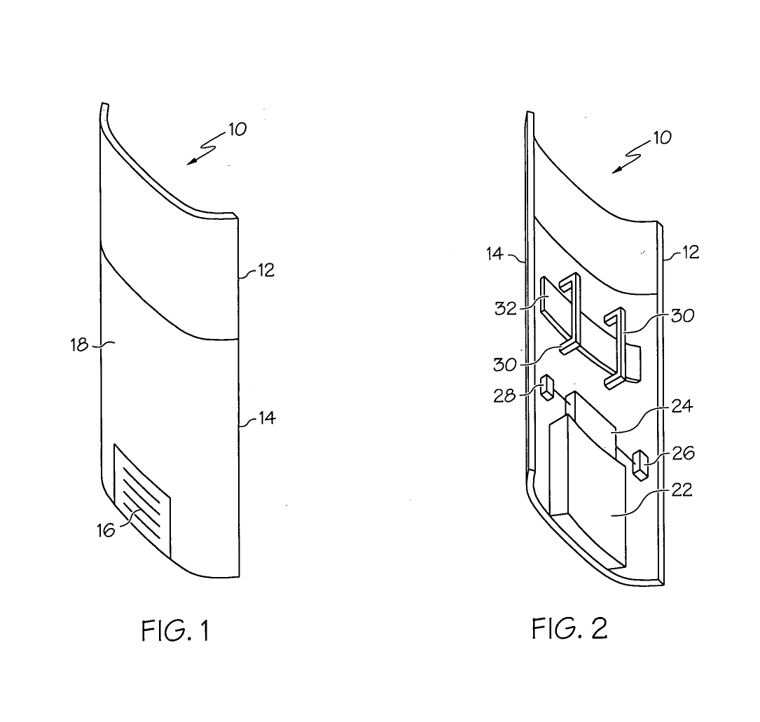

Referring now to the drawings and in particular to FIGS. 1 and 2, a shield 10 is shown. Shield 10 includes an upper shield section 12 and a lower shield section 14 and is intended to be carried with upper shield section 12 above lower shield section 14. Upper shield section 12 may be made of a clear polycarbonate material and may be made detachable to allow replacement in case scarring or other damage obscures its transparency. Lower shield section 14 may be made of a carbon fiber material selected for impact resistance and low weight. The outer skin forming both the front surface 18 and the rear surface 20 may be a carbon fiber skin with an inner core being a honeycomb carbon fiber composite material.

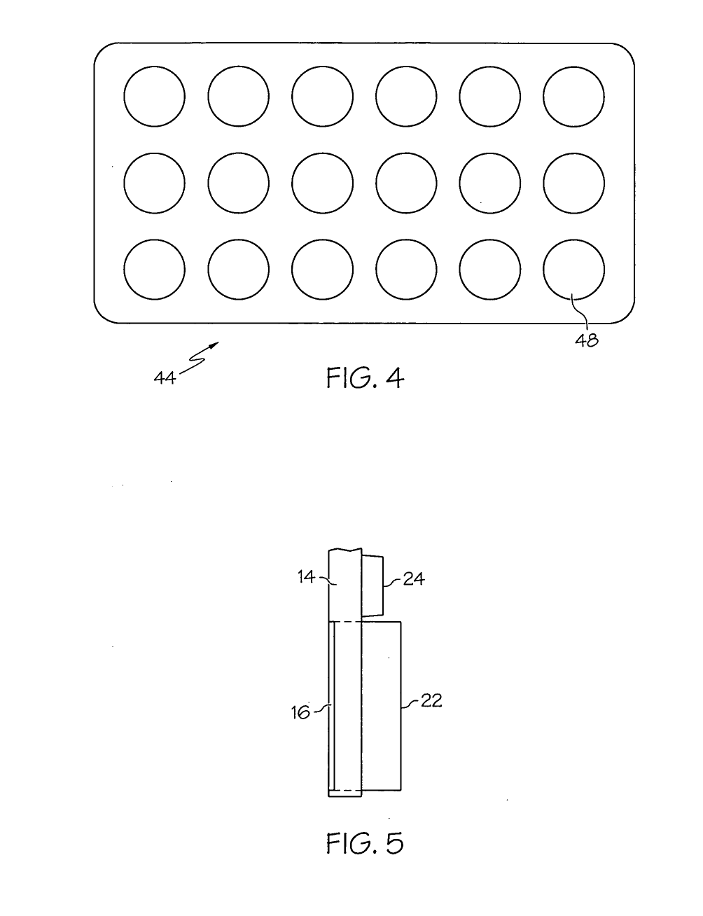

Upper and lower shield sections 12 and 14 are thin and conform to a shallow arcuate shape which slopes back along the edges of a front major surface/face 18. Front major surface 18 is intended to be presented toward a crowd. A grill 16 covers a loudspeaker system. The loudspeaker system may be implemented using a loudspeaker array 44 (shown in FIGS. 4 and 5). The loudspeaker array 44 is installed in a housing 22 which extends through lower shield section 14 to direct sound from the loudspeaker array forward. Sound is radiated, primarily forward or outward from the front major surface, through grill 16. Arrangement of the loudspeakers in a loudspeaker array 44 controls beam shape and spread.

Attached to the rear surface 20 of shield 10 and to lower shield body 14 are an electronics package housing 24, an external (and accessible) battery pack 26, a microphone 28, grips 30 and padding 32. Padding 32 is aligned with the grips 30 for cushioning an arm fitted through the grips 30 allowing a single officer to conveniently carry the shield and to position the shield for personal protection. Battery pack 26 and microphone 28 are connected by wiring to electronics package housing 24.

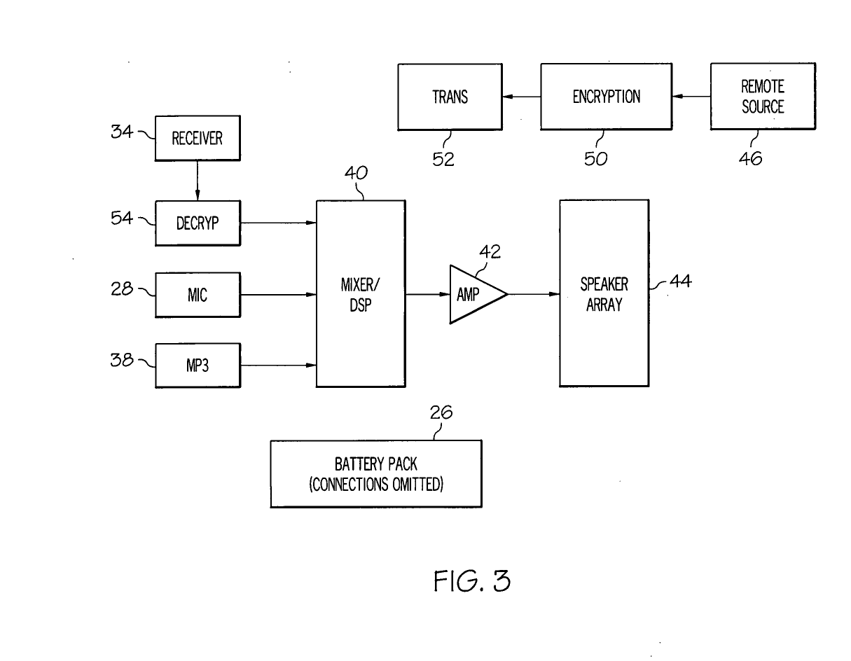

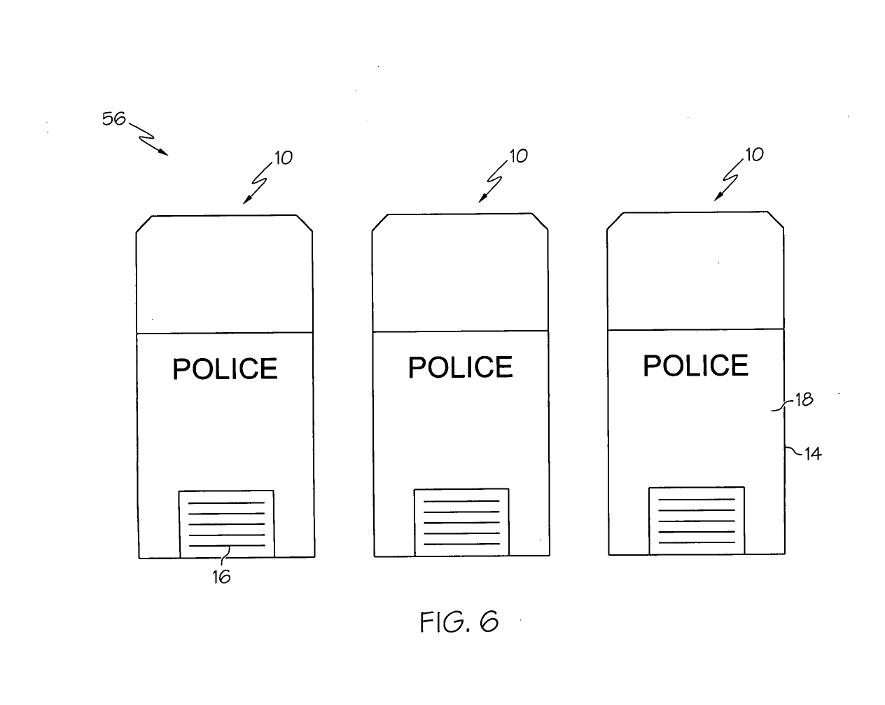

Referring now to FIG. 3, a block diagram of electronics relating to operation of loudspeaker array 44 and providing either local or centralized, remote control over a plurality of such arrays 44 is illustrated. Loudspeaker array 44 is energized from one or more of a plurality of acoustic signal sources which may include, by way of example, an MP3 player 38, microphone 28, a receiver 34 and a decryption module 54 for use with the receiver 34. MP3 player 38 provides a local source of operator selectable signals for acoustic reproduction. Microphone 28 provides for local public address functions. The receiver 34 and decryption system 54 allow for reception of signals from a remote source 46 for playback. Signals from any of these sources are supplied to a mixer/digital signal processor 40 and passed from there through an amplifier 42 for application to the loudspeaker array 44. Signals from remote source 46 may be encrypted at an encryption stage 50 before being passed to a transmitter 52 for transmission to one or more shields 10. Individual shields 10 may be assigned unique identification numbers allowing selected shields to be activated. Provision of global positioning devices on shields 10 may allow inclusion of a transponder which would allow quick organization of a group of shields 10 into a larger array 56. Remote source 46 can supply a common signal to a plurality of arrays 44 represented in FIG. 6. Power is provided from a battery pack 26 for which the power connections have been omitted for the sake of clarity. It is theoretically possible for the arrays 44 to be positioned in a line array 56 by shield 10 bearers for constructive interference between sound fields emitted by the loudspeaker arrays 44 at very low frequencies, probably based on conventional loudspeakers. This allows generation of a sound field much stronger than can be generated by the array 44 for a single shield 10. Encryption of signals from the central source mitigates the possibility of the system being hijacked.

FIG. 4 illustrates a possible arrangement for an array 44 of light weight, horn loaded piezoelectric transducers 48. Alternatively, conventional loudspeakers could be used at some penalty in weight. Use of array allows use of constructive reinforcement of acoustic energy. Operation of an array 44 as a phased array allows the resulting acoustic beam to be stirred or focused. FIG. 5 illustrates positioning of an array housing 22 through a lower shield body oriented to direct sound forward from the shield through grill 16.

Shields 10 combine conventional protective features of a shield with the ability to effect a standoff deterrent for crowd control. Arrays 44 can operate in high ambient noise environments and remain effective due to the ability to generate loud sounds. For example, up to 140 dB of acoustic output at 1 meter distance forward from a shield 10 can be produced from an array of nine piezoelectric speakers operating at 122 dB each. Alternative arrangements are possible to produce even louder sounds. The ability to produce significant auditory discomfort helps establish up to a 50 meter standoff distance using piercing alert tones and still allow broadcast of intelligible messages. For a nine loudspeaker piezoelectric system the beam width is less than 20 degrees conical at 2 kHz and the effective range is 400 meters. The frequency range is 800 Hz to 23 kHz. As a package a weight of only 7.3 kg, including battery pack 26, is obtained. The operational range of a system built of conventional units can range from 200 Hz to 14 kHz.

What is claimed is:

1. Apparatus comprising:
a shield having a front major surface and a rear major surface;
an array of loudspeakers mounted through the shield to project sound outwardly from the front major surface; and
a signal source for driving the high intensity loudspeaker including means for supplying signals for recorded auditory warnings or tones to the high intensity loudspeaker system.

2. Apparatus according to claim 1, further comprising:
the signal source including a microphone.

3. Apparatus according to claim 1, further comprising:
the signal source including a receiver and a remote transmitter, communication between the remote transmitter and receiver enabling reproduction over the loudspeaker array of broadcast or narrowcast signals from the remote transmitter.

4. Apparatus according to claim 1, further comprising:
the signal source including a recorded signal playback device.

5. Apparatus according to claim 3, response to the remote location allowing a plurality of shields to be mutually located for constructive interference.

6. A shield comprising:
a front major surface and a rear major surface supports;
a loudspeaker array mounted with respect to the shield to project sound outwardly from the front major surface; and
means for applying an acoustic drive signal to the loudspeaker array.

7. A shield as set forth in claim 6, further comprising:
the means for applying an acoustic drive signal including local signal sources including a microphone, a receiver for broadcast or narrowcast signals, and a recorded signal playback device.

8. A shield as set forth in claim 7, further comprising:
the means for applying an acoustic drive signal including a remote signal source.

9. A crowd control system comprising:
a plurality of personal shields;
an array of loudspeakers supported through each personal shield;
a central source of acoustic signals for application to arrays of loudspeakers by remote broadcast or narrowcast of a signal; and
a unique electronic identification associated with each personal shield allowing selection of particular personal shields for application of an acoustic signal.

10. A crowd control system as set forth in claim 9, further comprising:
arrangement of a set of the personal shields and application of a signal under the direction of the central source to produce a directed and constructively interfered beam.

11. A crowd control system as set forth in claim 10, further comprising:
each personal shield incorporating a local source of an acoustic signal.
